(19) United States
(12) Patent Application Publication
(10) Pub. No.: US 2010/0064146 A1
(43) Pub. Date: Mar. 11, 2010

(54) POWER SYSTEM DESIGN TOOL

(75) Inventors: David A. Boles, Austin, TX (US); Jonathan Cassorla, Austin, TX (US); William Otto Tschumy, III, Austin, TX (US)

Correspondence Address: Integral Wave Technologies, Inc.;c/o DeLizio Gilliam, PLLC, 15204 Mason Road, Suite 1000-312, Cypress, TX, 77433, US

(73) Assignee: Integral Wave Technologies, Inc., Austin, TX (US)

(21) Appl. No.: 12/206,398

(22) Filed: Sep. 8, 2008

(51) Int. Cl. G06F 1/26

(52) U.S. Cl. 713/300

(57) ABSTRACT

A power system, which can comprise multiple power subsystems (e.g., one or more power converters sources, etc.) delivers one or more rails of power to a system. The performance of a power system is thermally limited and depends on the different components' specifications. A power system design tool that dynamically generates constraints based on design specifications and power system configurations allows for robust and intelligent validation of a power system design. The power system design tool that allows for robust and intelligent validation of a design facilitates thorough designs that account for numerous factors that can affect a power system. Further, a power system design tool that generates a configuration file in accordance with a validated design, allows for efficient and automatic configuring of a configurable component of a power system.

### BACKGROUND

Embodiments of this patent application generally relate to the field of design tools, and more particularly, to a design tool for power subsystems.

A power system includes multiple power subsystems (e.g., a power converter and a source), and is typically used to deliver one or more rails of power to a consumer system (e.g., integrated circuit that consumes the power). The performance of a power converter is limited by a set of constraints and also depends on its surrounding environment (e.g., the consumer system in which it is connected, specifications of other components of the consumer system, etc). In designing a power system, an engineer typically solders different connections and/or components until the desired performance is achieved through trial and error.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example power system design tool user interface.

FIG. 2 depicts configuration of inter-dependent power converter outputs using the example power system design tool.

FIG. 3 depicts a capability of the power system design tool to generate a power converter configuration file.

FIG. 4 depicts a conceptual diagram of an example power system design tool.

FIG. 5 depicts a flow diagram of example operations for configuring and validating a power system design.

FIG. 6 depicts a flow diagram of example operations for processing a power system design.

FIG. 7 depicts a flow diagram of example operations for dynamically generating power converter constraints.

FIG. 8 depicts a flow diagram of example operations for dynamically generating power system constraints.

FIG. 9 depicts a flow diagram of example operations for validating a power system design.

FIG. 10 depicts a flow diagram of example operations for generating power system design feedback.

FIG. 11 depicts a flow diagram of example operations for design error notification.

FIG. 12 depicts a flow diagram of example operations for generating a power converter configuration file.

FIG. 13 depicts an example computer system that embodies a power system design tool.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, examples refer to a power converter as a configurable component of a power system. But embodiments should not be limited to a power converter and can generate configuration files for other types of configurable components of a power system. In some instances, well-known instruction instances, protocols, structures, and techniques have not been shown in detail in order not to obfuscate the description.

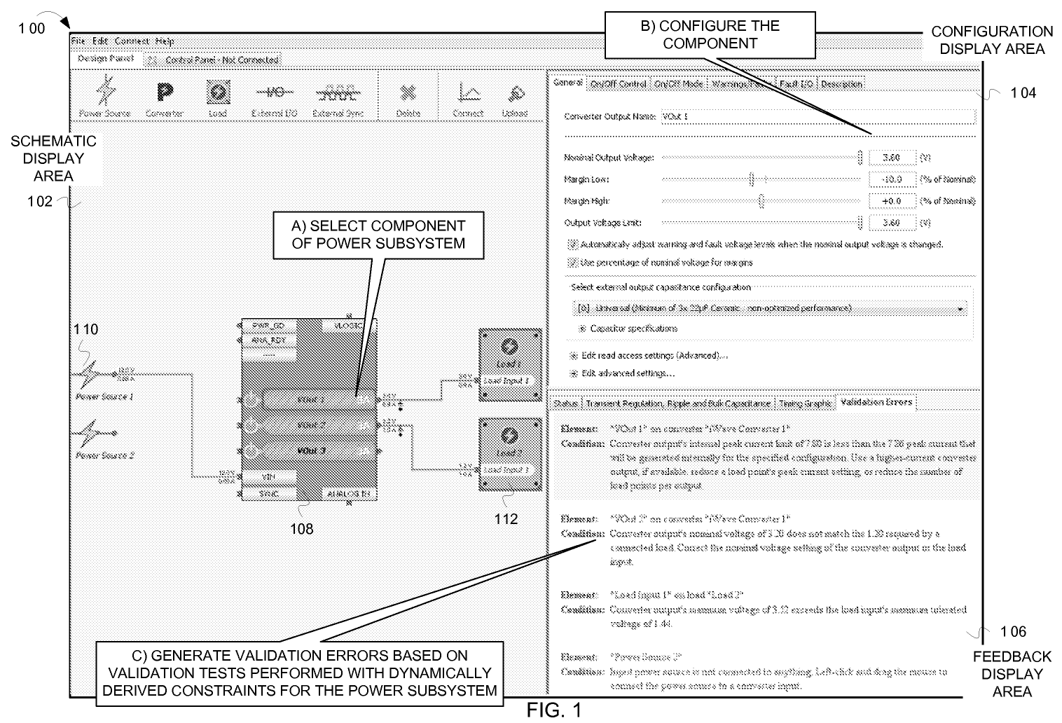

A power system, which comprises a plurality of power subsystems (e.g., one or more power converters, sources, etc.), delivers one or more rails of power to a consumer system (e.g., a system coupled with or encompassing the power system that consumes the power). A power subsystem can comprise different components, possibly including components which dissipate some energy in the form of heat (e.g., inductors that dissipate heat during power conversion). Since a power subsystem and a component of a power subsystem are both components from the perspective of the power system, “component” will be used herein to refer to any one of a power subsystem, a component of a power subsystem, and a component of a consumer system (e.g., load). The performance of a power system may be thermally limited and depends on different components' specifications. A power system design tool that dynamically generates constraints based on design specifications and power system configurations allows for robust and intelligent validation of a power system design. The power system design tool that allows for robust and intelligent validation of a design facilitates generation of thorough designs that account for numerous factors that can affect a power system. For instance, the power system design tool can take into account the effect of the consumer system in which a power converter must operate (e.g., power sources, loads, number of power rails, load inputs, other I/O devices, constraints on loads, ambient temperature, etc.), as well as taking into account the interactions between different components while configuring a power converter (e.g., timing relationship between two power rails). Further, a power system design tool that generates a configuration file in accordance with a validated design, allows for efficient and automatic configuring of a configurable component of a power system. FIGS. 1-3 depict an example power system design tool user interface and convey some example functionality.

FIG. 1 depicts an example power system design tool user interface. An example power system design tool user interface 100 includes three areas—a schematic display area 102, a configuration display area 104, and a feedback display area 106. The schematic display area 102 allows dragging and dropping of different components to design a power system (e.g., power sources 110, power converter 108, loads 112, input/output (I/O) devices, etc.). The schematic display area 102 also allows arranging and connecting of components to design a power system. The configuration display area 104 allows adjusting of different parameters. Examples of parameters that can be adjusted include parameters associated with each of the components in the schematic display area 102, environmental parameters (e.g., ambient temperature), etc. The feedback display area 106 presents information about the status of the power system design, design errors (illustrated as information presented in validation errors tab in this example), output timing diagrams, etc.

The schematic display area 102 depicts an example power system design schematic including two power sources 110 (depicted as Power source 1 and Power source 2), a three rail power converter 108, and two loads 112 (depicted as Load 1 and Load 2). Power source 1 is connected to the input terminal (VIN) of the power converter 108. Power source 2 is not connected to anything. VOut1 (power converter output 1) is connected to Load 1's input terminal, while VOut2 (power converter output 2) is connected to Load 2's input terminal. The component VOut1 represents the hardware (e.g., transistors, ICs, etc.) that generates the voltage at output terminal 1 of the power converter 108. The configuration display area 104 displays parameters associated with the selected component, which is VOut1 in FIG. 1. For example, parameters associated with VOut1 include nominal output voltage, output voltage limit, warning thresholds, etc. The feedback display area 106 can present errors in the form of general warnings indicating an erroneous connection (e.g., power source 2 is not connected to anything) or errors associated with component specifications (e.g., converter output voltage does not match the load's required input voltage, etc).

In FIG. 1, a few example stages depict some functionality of the power system design tool as conveyed by the interface 100. In a stage A, a user draws a schematic of the power system by selecting (e.g., dragging and dropping, clicking, etc.) components, and connecting the selected components together. The user can further configure individual components. As shown in the schematic display area 102, a component VOut1 of the power converter 108 is graphically highlighted in response to a user selecting the component VOut1 of the proposed power system. In stage B, the user can configure the selected component by moving sliders, selecting options in a drop down menu or entering values in a textbox. In FIG. 1, the user moves sliders to set the nominal output voltage (for VOut1) at 3.60V, the margin low at −10% of the nominal, the maximum output voltage at 3.60V, etc.

In stage C, the power system design tool generates validation errors based on validation tests performed with dynamically derived constraints for the power system based on specifications generated from the schematic and parameters. The power system design tool displays the validation errors in the feedback display area 106. The validation errors in the feedback display area can be associated with one or more design specifications. A design specification can be realized as a data that represents a component of a power system, a parameter associated with a component of the power system, or a connection between components. In addition, the power system design tool can also present, via the feedback display area 106, solutions to the system design errors. For example, the power system design tool indicates via the feedback display area 106 that the converter's output voltage (VOut2) of 3.20V does not match the connected load input (Load 2) voltage requirement of 1.2V, and suggests that the user correct one of the voltages so that they are equal. The feedback display area 106 also displays connection errors (e.g., power source 2 is not connected to anything)

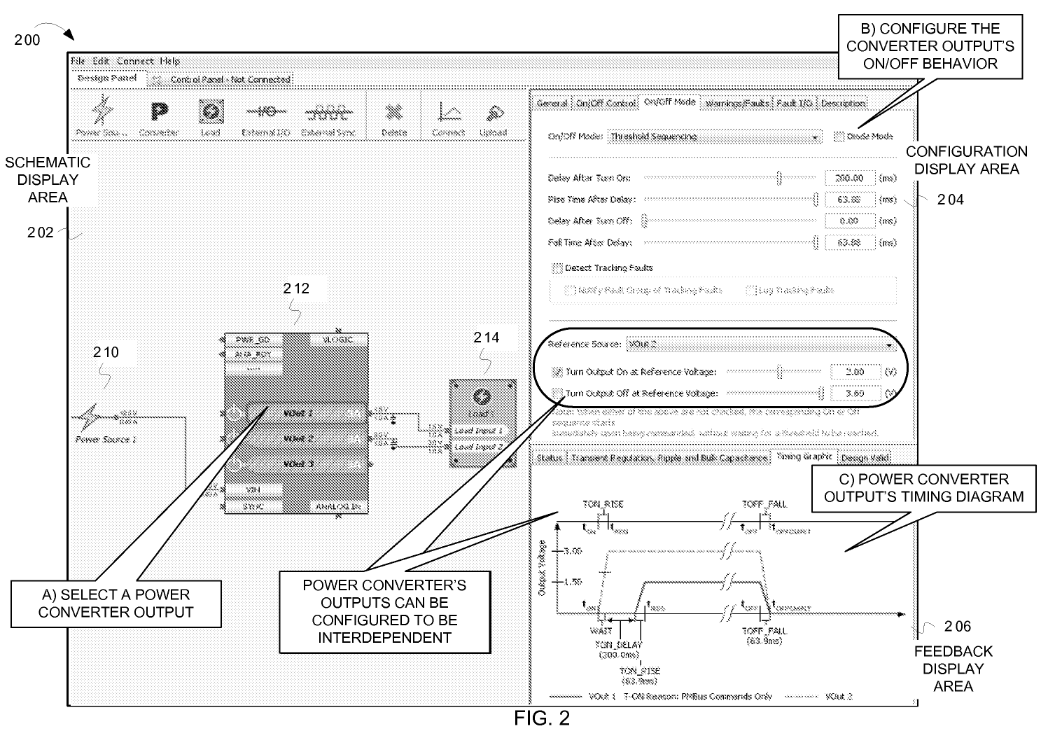

Sometimes, two rails in a power system can have a timing relationship. For example, one rail in a power system can be configured to turn on (i.e., supply an output voltage) when another rail in the power system reaches a specified voltage level. FIG. 2 depicts configuration of inter-dependent power converter outputs using the example power system design tool. The schematic display area 202 depicts an example power system design schematic including a power source 210, a three rail power converter 212, and a dual input load 214. The power source 210 is connected to the input terminal (VIN) of the power converter 212. VOut1 (power converter output 1) is connected to load input 1, while VOut2 (power converter output 2) is connected to the load input 2. The load 214 takes two different rails (VOut1 at 1.5 V and VOut2 at 3V). The power converter's voltages (VOut1 and VOut2) can be configured so that they are interdependent.

In stage A, a user selects the dependent voltage output (i.e., VOut1). The power system design tool updates a configuration display area 204 to present the default configuration for VOut1. In stage B, the user can specify an On/Off mode (e.g., threshold sequencing (dependent on/off mode), timed sequencing (independent on/off mode), etc). The power system design tool interface 200 depicts the power converter's output (VOut1) in threshold sequencing mode. Here, the power system design tool allows the user to select the reference source (i.e., the voltage source on which VOut1 is dependent; in this case the reference source is VOut2). Additionally, the user can also specify a reference voltage level (V_REF) at which the dependent voltage source turns on. The user can also specify timing parameters such as delay after turn on (TON_DELAY), rise time after delay (TON_RISE), fall time after delay (TOFF_FALL), etc. In stage C, the power system design tool updates its feedback display area 206 to present the power converter's output timing diagram. The timing diagram indicates the relationship between the on/off cycles of the power converter's outputs based on the specified timing parameters. The reference source VOut2 (represented by a dashed line) has an output voltage of 3V. The dependent voltage source VOut1 (represented by the solid line) turns on when the reference output voltage (VOut2) reaches 2V (V_REF), waits for a period of 200 ms (TON_DELAY) before rising to its maximum output voltage (1.5V) in 63.9 ms (TON_RISE).

The three stages described in FIGS. 1 and 2 are intended to illustrate example functionality, and should not be use to limit embodiments to the depicted stages and should not be used to limit embodiments to serial occurrence. The operations characterized by the different stages can occur simultaneously. For example, in some instances, stages B and C can occur simultaneously, and a change in one of the parameters in the configuration display area reflects a change, in real time, in the feedback display area.

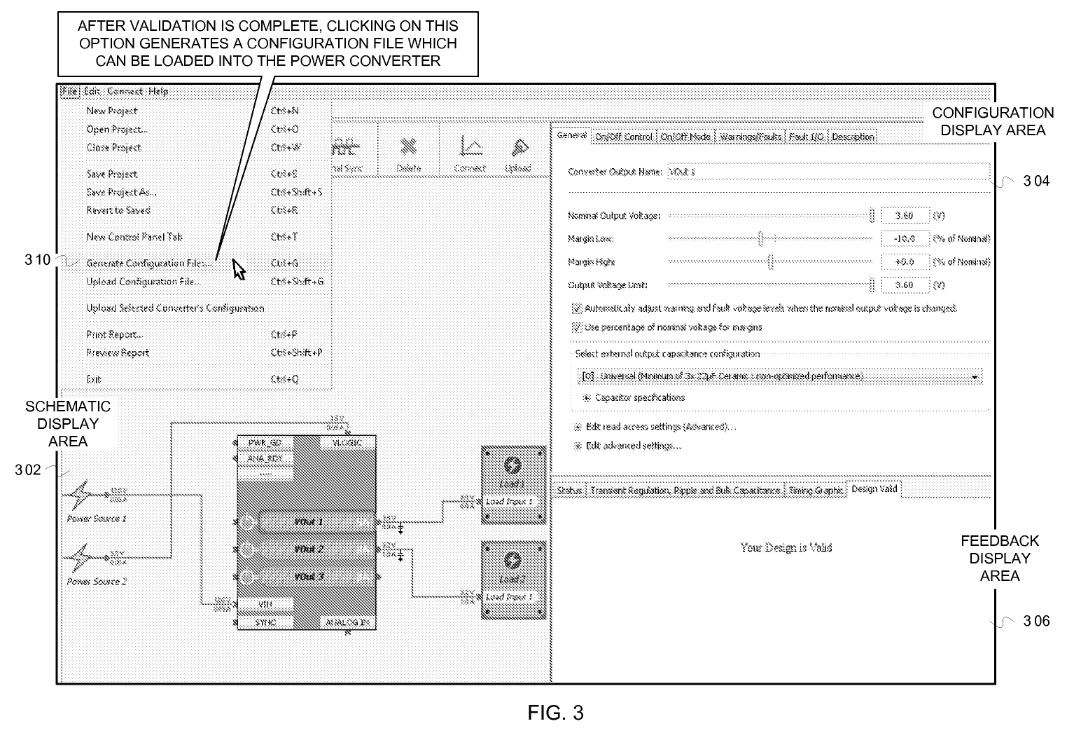

FIG. 3 depicts a capability of the power system design tool to generate a power converter configuration file. The power system design schematic presented in the schematic display area 302 is similar to the schematic presented in FIG. 1, with two power sources, a three rail power converter, and two loads. The configuration display area displays parameters associated with a selected component (e.g., VOut1). Because this is a valid design, there are no design errors and the feedback display area 306 reflects this with a “your design is valid” message. After the power system design has been validated, clicking on a “generate configuration file” option 310 generates a configuration file for the power converter. The configuration file can include information to enable the power converter to have the desired performance when in operation with other components in a system. This configuration file can be loaded onto the power converter chip (e.g., power converter's registers, EPROM, etc.) to configure its initial settings when the system is powered on.

The user interface depicted in FIGS. 1-3 should not be used to limit embodiments. A power system design tool user interface can have less functionality and/or flexibility for less advanced users, postpone validation tests and/or messages or postpone error messages until explicitly requested, different controls (e.g., fields instead of sliding bars), etc. In addition to different interface realizations, embodiments can implement the power system design tool differently.

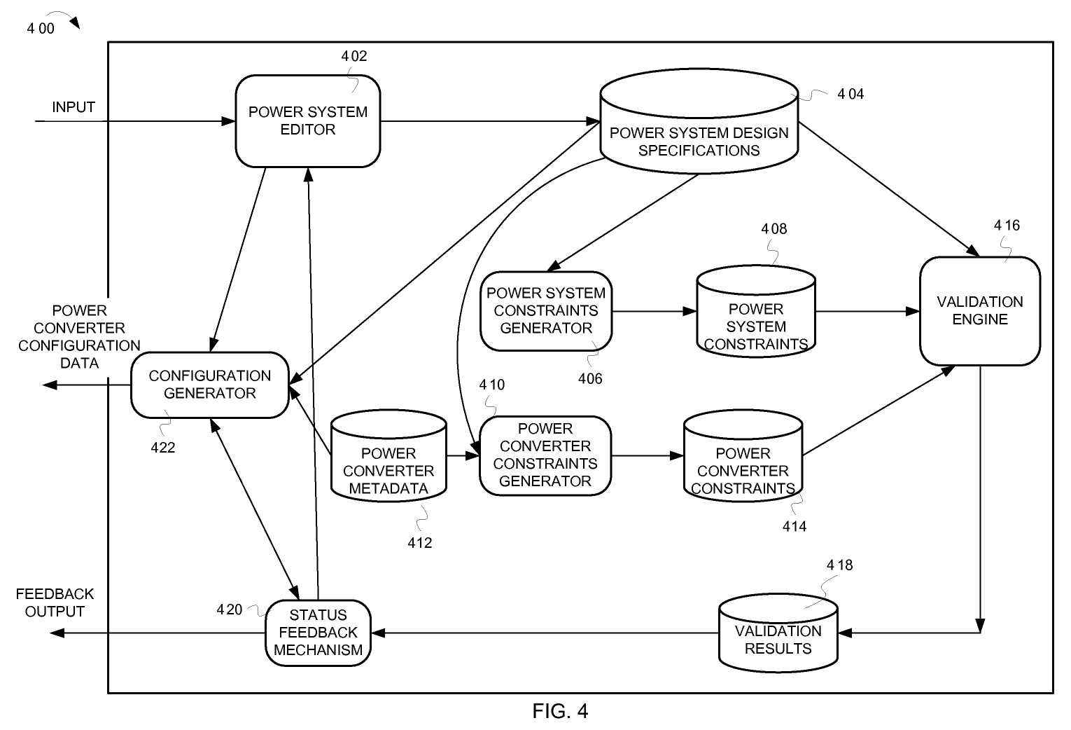

FIG. 4 depicts a conceptual diagram of an example power system design tool. The power system design tool 400 includes a power system editor 402 and a power system design specifications database 404. The power system editor 402 allows users to indicate design specifications. These design specifications describe the power system design and can include information such as the number of power rails, the current and voltage requirements of the rails, voltage regulation requirements, turn on/turn off sequences, behavior in the presence of fault conditions, etc., which are then stored in the power system design specifications database 404.

The power system design tool 400 also includes a power system constraints generator 406. The power system constraints generator 406 accesses the power system design specifications database 404, and dynamically derives a set of power system constraints based on the power system specifications. The power system constraints define the limits of the power system's operations (e.g., peak currents, operating voltages, etc). The power system constraints generator 406 can be implemented with a set of conditionals, equations, etc. for dynamically deriving the power system constraints. Embodiments can also realize the power system constraints generator 406 with a reference to one or more locations (e.g., address, filename, etc.) that host the conditional statements, equations, etc. The power system constraints generator 406 stores the dynamically derived set of power system constraints in a power system constraints database 408.

The power system design tool 400 also comprises a power converter constraints generator 410. The power converter constraints generator 410 accesses the power system design specifications 404 and power converter metadata 412, and dynamically derives a set of power converter constraints. Examples of the power converter metadata 412 include data that indicates the performance (and operation) of the power converter (e.g., trace resistance between components in the power converter chip, maximum die temperature, etc). The set of power converter constraints 414 define the operation of the power converter within the context of the proposed power system (i.e., with respect to the design specifications) (e.g., constraints related to the device's junction temperature, the wire's current carrying capabilities, etc). The power converter constraints generator 410 stores the dynamically derived power system constraints in a power converter constraints database 414.

Every component, connection, and specification can be associated with one or more constraints. In some instances, these constraints can be classified as physical constraints wherein design specifications must lie within a specified range (e.g., fault threshold should be less than the warning threshold, peak current should be less than the wire's current carrying capability, etc.) and logical constraints (e.g., no input power source, input data values must belong to the set of real numbers, etc.).

The power system design tool 400 ensures that a power system design complies with the dynamically derived constraints (power system constraints and power converter constraints) with a validation engine 416. The validation engine 416 determines whether the power system design specifications 404 that represent a power system design comport with the restrictions described by the power system constraints and the power converter constraints. The validation engine 416 accesses the power system design specifications database 404, the power system constraints database 408, and the power converter constraints database 414. The validation engine 416 evaluates a power system design against one or more validation tests with the dynamically derived constraints, and design specifications. The validation engine 416 indicates results of the evaluation in a validation results database 418. In some embodiments, the validation engine 416 may also store, in the validation results database 418, design specifications that correspond to constraint violations. In some instances, the validation engine 416 can store a copy of the actual design specifications associated with errors, while in other instances, the validation engine 416 can store references (e.g., memory addresses, pointers, etc.) to the design specifications. In addition, the validation engine 416 may also generate an event and indicate to a status feedback mechanism 420 whether the proposed power system design is valid or not.

The status feedback mechanism 420 causes information to be provided that indicates errors in accordance with various techniques. The status feedback mechanism 420 can generate and display messages or notifications. The status feedback mechanism 420 can generate messages, and then pass those messages (or a reference(s) to those messages) to the power system editor 402, assuming the editor 402 encompasses the user interface. The status feedback mechanism 420 can interact directly with the user interface or command a separate feedback interface. In addition, the status feedback mechanism 420 can log constraint violations to a remote and/or local location.

The power system design tool 400 also comprises a configuration generator 422. The configuration generator 422 generates configuration data (e.g., a configuration file) for a configurable power converter based on a valid power system design. The configuration generator 422 generates the configuration data based on the design specifications and the power converter metadata 412. When the configuration generator 422 detects a request to generate a configuration file, it may interface with the status feedback mechanism 420 to determine whether all the design errors have been resolved and whether the design is valid. If the proposed power system design has unresolved errors, the status feedback mechanism 420 can direct the configuration generator 422 to present a message informing a user that configuration data cannot be generated based on an invalid power system design.

In some embodiments, one or more of the power system design specifications database 404, the power system constraints database 408, the power converter constraints database 414, the power converter metadata 412, and the constraint violations database 418 may not be a part of the power system design tool 400 and may be separate from the design tool. One or more of the databases mentioned above may be a part of different runtime spaces, on separate hard drives, external memory devices, etc. Further, the term “database” has been employed for ease of illustration, and narrow construction of the term should not be used to limit embodiments. The data stored in these example databases can be stored in accordance with any of a variety of data structures and types of data stores (e.g., a hardware table, directory, etc.). Moreover, the different data can be stored together (e.g. power system constraints and power converter constraints can be stored in a single hash table).

As a power system is defined, the design tool dynamically derives system constraints based on the input specifications and data about the power converter (e.g., power converter metadata), keeps track of device constraints and constraints based on design specifications, determines whether the constraints are being satisfied at all times, and indicates any conditions that are of concern or that represent an error. When the proposed design is deemed “error-free”, the user can request the generation of configuration data (or the design tool can automatically generate power converter configuration data) that will instantiate the power converter in the designed power system. Moreover, it is possible to initially configure the operations and allow the user to dynamically modify the operation of the power system at any stage (e.g., design phase, testing phase, manufacturing phase, etc).

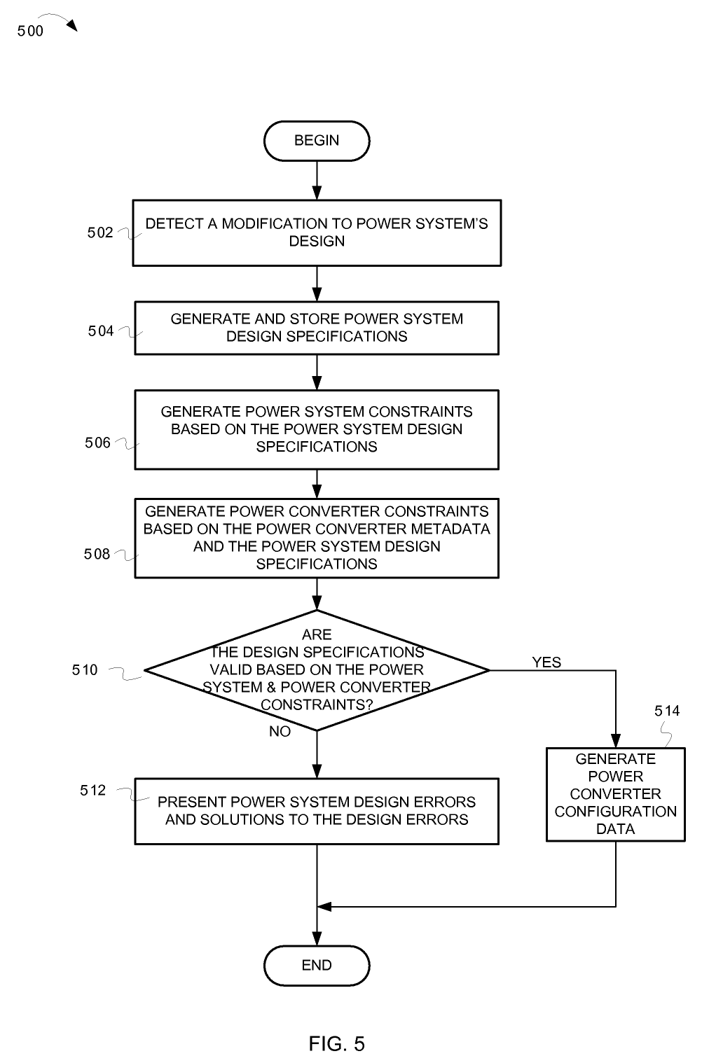

FIG. 5 depicts a flow diagram of example operations for configuring and validating a power system design. The flow 500 begins at block 502.

At block 502, a modification to a power system's design is detected. A modification to the power system design can include the addition or deletion of components (e.g., power sources, loads, power converters, I/O devices, etc.), connections between components, and change in values associated with any one or more of the components (e.g., ripple voltage, percentage load regulation, maximum output voltage, etc). In some instances, the power system design tool's interface can include logic to detect and communicate a design input. The flow continues at block 504.

At block 504, the power system design specifications are generated and stored. A design specification can include a parameter associated with a component of the power system or a description of connections between components. The design specifications can be stored in a database in the processor's RAM (or cache) for efficient access or on an external hard drive. In some instances, a design specifications database may be updated every time a specification is modified. In other instances, a batch of design specifications may be written to the hard drive at regular intervals. In some instances, a specified number of previous operations may be retained in the cache to determine design modifications and prevent redundant writing of design modifications. For example, if update #3 cancels update #1, the design tool could write update #2 to the specifications database and ignore updates 1 and 3. The flow continues at block 506.

At block 506, the power system constraints are dynamically generated based on the power system design specifications. In some instances, constraints can be classified as those related to physical connectivity (e.g., power source must be connected to a converter input), electrical performance (e.g., nominal load current should be less than or equal to the peak load current, etc.), thermal performance (e.g., the junction temperature within a component must be less than the maximum ambient temperature), and logical constraints (e.g., conditional constraints ensuring that parameters are within a specified range). The flow continues at block 508.

At block 508, the power converter constraints are dynamically generated based on the power system design specifications and the power converter metadata. These constraints can be based on the power system's operating environment (e.g., ambient temperature) and the characteristics of the power converter (e.g., maximum allowable current through wire, trace length, trace resistance, etc). The flow continues at block 510.

At block 510, it is determined whether the design specifications are valid based on the power system constraints and the power converter constraints. The power system design tool can include hardcoded or software logic to ensure that the power system design specifications meet the generated constraints. For example, a constraint might limit the maximum amount of current running through a wire to 4 A. If the design specifications indicate that the peak current consumed by a load is 5 A, it would violate the constraints and generate an error thus invalidating the power system design. If the power system design specifications are valid, the flow continues at block 514. Otherwise, the flow continues at block 512.

At block 512, the power system design errors and possible solutions to these design errors are presented. In some instances, the power system design errors, the components and specifications associated with the errors, and possible solutions to the errors can be stored in a database as part of the design tool or separate from the design tool (e.g., external memory device). Referring to the example above, the power system design tool can display, as an error, that the peak load current consumed is greater than the wire's current limit. The power system design tool may also indicate that the load's peak current specification is a possible basis for the error and suggest that the user decrease the load's peak current below 4 A to resolve the error. From block 512, the flow ends.

At block 514, a power converter configuration data is generated. The configuration data is generated after the constraints are satisfied and the power system design has been validated. The configuration data can be loaded onto the power converter chip and include information to ensure that the power converter chip operates at the specified performance level. From block 514, the flow ends.

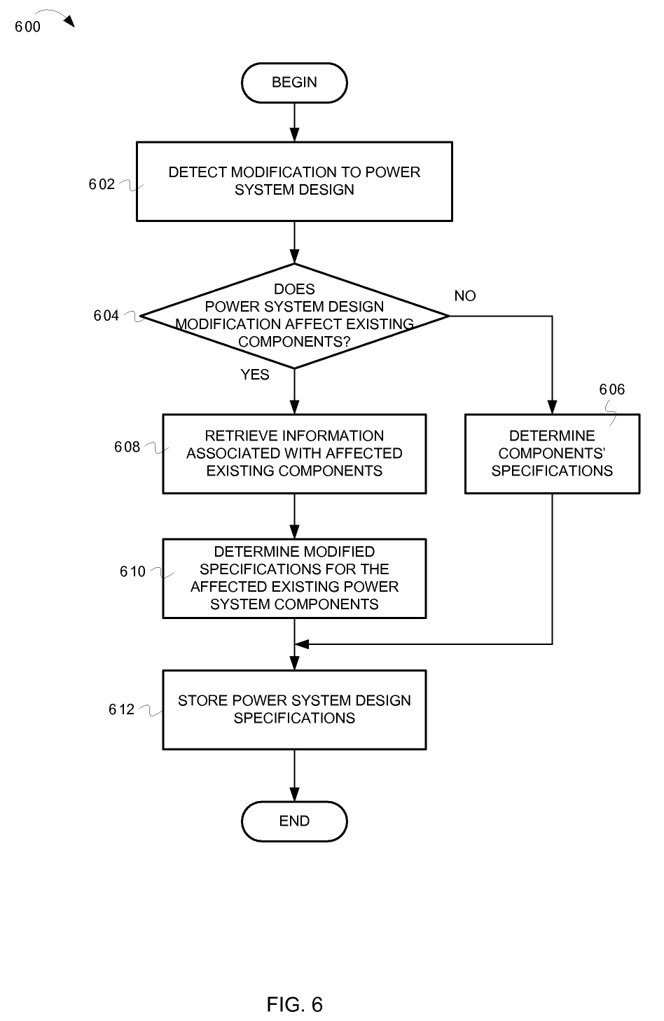

FIG. 6 depicts a flow diagram of example operations for processing a power system design. The flow 600 begins at block 602.

At block 602, a modification to the power system design is detected. A modification to the power system design can include the addition or deletion of components (e.g., power sources, loads, number of load inputs, power converters, I/O devices, etc.) and connections between two or more components. Power system design modifications can also include a change in values (or parameters) associated with each of the components (e.g., nominal output voltage, peak output current, percentage load regulation, load input voltage values, etc) or a relationship between power rails (e.g., timing relationship between two outputs of a power converter). In some instances, the power system design tool's interface can include logic to detect and communicate a design modification. The flow continues at block 604.

At block 604, it is determined whether the power system design modifications affect existing components. In some instances, the power system design tool can access a list of existing components in the design schematic and determine whether the new design specification can be associated with one of the existing components. If the power system design modifications affect one or more of the existing components, the flow continues at block 608. Otherwise, the flow continues at block 606.

At block 608, information associated with the affected existing components is retrieved. Embodiments can vary from representing every component of a power system (e.g., load, power source, power converters, connections, etc.) with a separate data structure to representing the a power system design with a single monolithic data structure. The flow continues at block 610.

At block 610, the modified specifications for the specified power system components are determined. The power system design tool can compare the specified component's parameters with the component's retrieved specifications (refer to block 608) to determine which parameters have been updated. In some instances, all the information (parameters, connections, etc.) associated with the specified component may be determined and recorded. The flow continues at block 612.

At block 612, the power system design specifications are stored. In some embodiments, when a new component is added to the system, a new data structure can be created for the specified component. Also, in some instances, the data structure representing the new component can include default parameters associated with the component, while in other instances; an empty data structure may be created and populated as the component is configured. In some instances, deleting a component can lead to the deletion of the data structure that represents the component, while in other instances the data structure can be marked for removal to delay actual deletion. Additionally, component connections can be indicated in the component's data structure or in a separate data structure. From block 612, the flow ends.

At block 606, the components' specifications are determined. The flow 600 moves to block 606 coming from block 604, after it is determined that the design modifications do not affect an existing component. Component specifications can include parameter values input through the user interface, default component parameters, relationships between the new component and the existing components (e.g., timing relationships), connections between components, etc. The flow continues at block 612.

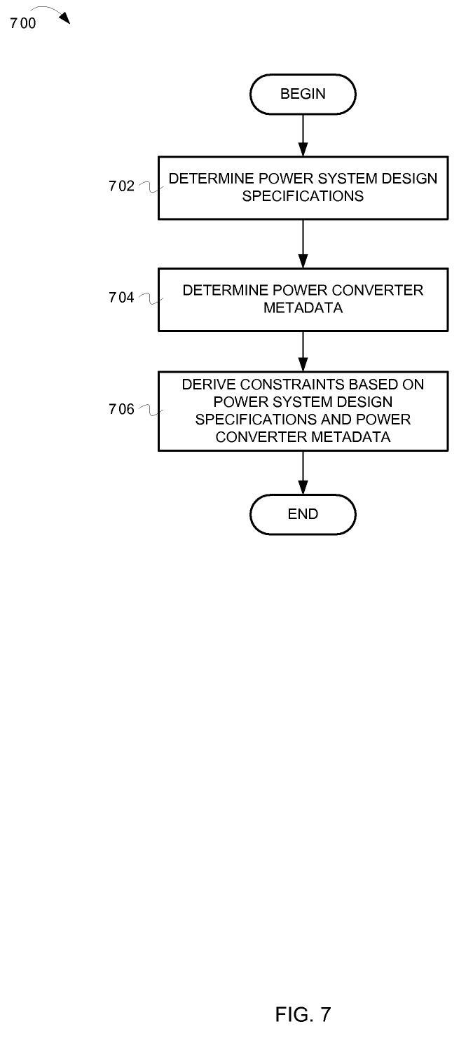

FIG. 7 depicts a flow diagram of example operations for dynamically generating power converter constraints. The flow 700 begins at block 702.

At block 702, a power system's design specifications are determined. In some embodiments, the power system design specifications (including components, connections between components, parameters associated with various components, etc.) can be stored in data structures. The power system design specifications can also be stored in RAM, on a hard drive, or on any other media suitable for storing data (e.g., flash memory). In other embodiments, some or all of the power system design specifications can be accessed from a component's metadata file. For example, the power system load (i.e., load connected to the power converter) can be an ASIC chip (purchased from a 3^{rd} party vendor) with a metadata file indicating the chip's specifications. In some instances only a subset of the power system design specifications may be retrieved and used to compute constraints. The flow continues at block 704.

At block 704, the power converter's metadata is determined. The power converter's metadata can include data describing the behavior and the limits of the power converter. Examples of power converter metadata include but are not limited to maximum die temperature, maximum ambient operating temperature, thermal performance of the power converter, power converter V-I characteristics, etc. The flow continues at block 706.

At block 706, the power converter constraints are derived based on the power system's design specifications and the power converter's metadata. In some embodiments, the design tool can include logic (hardcoded or software) to determine the power converter constraints. In some instances, the constraints can include equations representing physical constraints and conditional statements representing logical constraints. Some examples of power converter design constraints can include 1) the voltage applied to the power converter's LOGIC pin should be in the range [3.0, 3.6]; 2) the internal junction temperature should be less than the maximum tolerated temperature, etc. After the power converter constraints are determined, the flow ends.

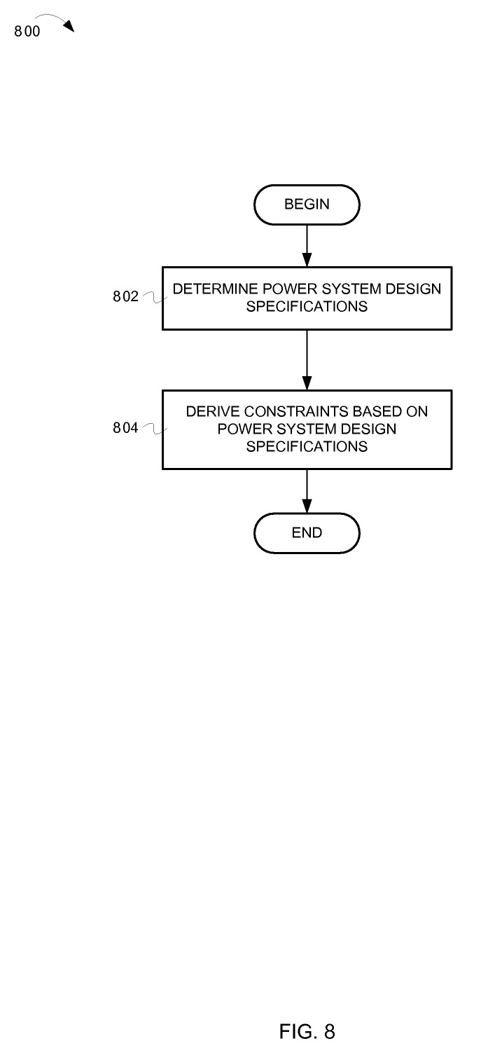

FIG. 8 depicts a flow diagram of example operations for dynamically generating power system constraints. The flow 800 begins at block 802.

At block 802, the power system's design specifications are determined. The flow continues at block 804.

At block 804, the power system constraints are derived based on the power system design specifications. In some instances only a subset of the power system design specifications may be used to derive the power system constraints. Examples of these constraints can include, 1) the sum of the peak currents for the power converter's conversion engine's attached power sinks must be less than or equal to its absolute maximum output current, 2) nominal load current should be less than or equal to its peak current, 3) the power source should have a maximum current capability (I_{SRC}_{_{—}}_{MAX}(P)), where P represents a power source, that can provide the peak downstream loads (I_{PEAK})

$$( i . e . , {I}_{SRC\_MAX} ( P ) \geq {\sum }_{∀ s ∈ Sinks ( P )} {I}_{PEAK} ( s ) ) ,$$

etc. After the power system constraints are determined, the flow ends.

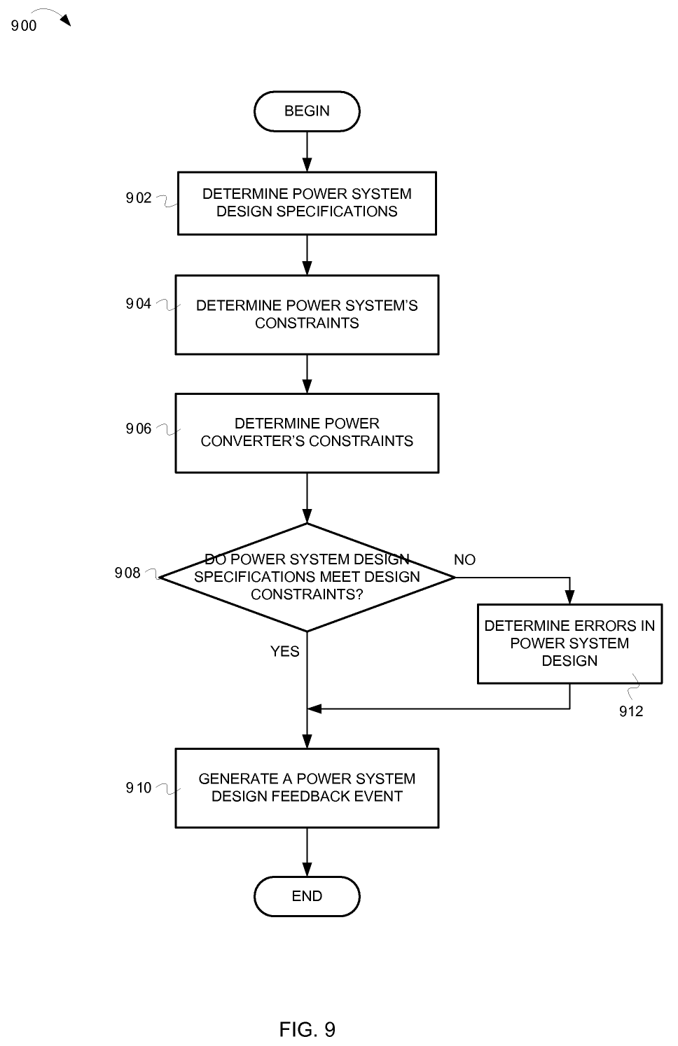

FIG. 9 depicts a flow diagram of example operations for validating a power system design. The flow 900 begins at block 902.

At block 902, the power system's design specifications are determined. The flow continues at block 904.

At block 904, the power system constraints are determined. The power system constraints can be dynamically derived from the power system design specifications as described in FIG. 8. Power system constraints typically address the operation of the power system as a whole and are concerned with the interaction of different components within the power system (e.g., a power converter's output voltage should match a connected load's input voltage). In some embodiments, the constraints can be stored locally in RAM, cache, hard disk, etc. Embodiments can also store constraints and/or design specifications remotely. The flow continues at block 906.

At block 906, the power converter constraints are determined. The power converter constraints can be derived from the power system design specifications and the power converter metadata as described in FIG. 7. Power converter constraints are generally related to the characteristics of the power converter and constrain the operation of the power converter within the system. These constraints can be associated with the internal thermal performance and electrical performance of the power converter. The flow continues at block 908.

At block 908, it is determined whether the power system design specifications meet the design constraints (i.e., the power system constraints and the power converter constraints). Some examples of validation tests include, 1) the voltage applied to V_{IN} (power converter's input terminal) should be in the range [9.6, 14.4] (i.e., 9.6≦V_{MIN}(V_{IN})̂V_{MAX}(V_{IN})≦14.4), 2) it is an error if no input power source has been connected to power converter's V_{IN} pin, 3) The maximum voltage from any connected power source should be within the maximum tolerated voltage limit, 4) in threshold sequencing mode with a reference rail R, the turn-on (V_{ON}(R)) and turn-off (V_{OFF}(R)) voltage level must satisfy V_{ON}(R)<V_{MIN}(R) and V_{OFF}(R)<V_{MN}(R), etc. If the power system design specifications meet the design constraints, the flow continues at block 910. Otherwise, the flow continues at block 912.

At block 912, errors in the power system design are determined. Examples of errors can include voltage or current mismatch between load and converter, junction temperature above the designed limit, CRC errors, etc. In some embodiments, the errors in the power system design can be stored in a database in the main memory. In some instances, the components or parameters associated with each error (or references to the specifications) can also be determined and stored in a database. The flow continues at block 910.

At block 910, a power system design feedback event is generated. The feedback event can be used to indicate the “correctness” of the power system design. In some instances, the feedback event can be generated every time there is a modification to the power system design, while in other instances, the feedback event can be generated after a batch of operations has been performed. The feedback event can be embodied as a Boolean metric (e.g., “true” implies a valid power system design and “false” implies an erroneous design) or as a more comprehensive metric including design errors, design specifications that could have caused the errors, and possible solutions to rectify the design errors. The flow ends after a feedback event is generated.

The discussion for FIGS. 7, 8, and 9 illustrate some constraints and validation tests performed by a power system design tool to ensure that the power system design meets the constraints. Constraints and validation tests, however, can vary across power system designs. A power system design and power converter metadata can drive what constraints and validation tests will be used, so it should not be presumed that the constraints and validations tests are statically defined within a tool or limited to those provided in a tool. Embodiments can override constraints and/or validation tests provided by a design tool. In addition, all or some constraints and/or validation tests can be accessed in a separate file, over the Internet with a query using model number(s) and/or a component manufacturer identification value(s), etc. Furthermore, new, additional, and/or replacement constraints and/or validation tests can be directly expressed by power converter metadata and/or by the power system design. As an example, power converter metadata for one power converter may indicate an acceptable voltage range for an input power source. Power converter metadata for a different power converter may instead indicate input power source voltage constraints conditioned on a range of operating temperatures for the power converter. Other examples of validation tests include,

For a power source (P)
1) The power source has a maximum current capability that can provide the peak

$$downstream loads \text{:} {I}_{SRC\_MAX} ( P ) \geq {\sum }_{∀ s ∈ Sinks ( P )} {I}_{PEAK} ( s )$$

### For a Power Converter (C)

1) If a converter has loads with non-zero current requirements, then it is an error if no input power source has been connected to the V_{IN} Pin (input voltage terminal).
2) The voltage applied to V_{IN} should be in the range [9.6, 14.4] 9.6≦V_{MIN}(V_{IN}) [symbol] V_{MAX}(V_{IN})≦14.4
3) The voltage applied to V_{LOGIC} (logic voltage pin) should be in the range [3.0, 3.6]: 3.0≦V_{MIN}(V_{LOGIC}) [symbol] V_{MAX}(V_{LOGIC})≦3.6
4) The voltage applied to ANALOG_IN (analog input pin) should be in the range [0.0, 3.6]: 0.0≦V_{MIN}(V_{ANALOG}_{_{—}}_{IN}) [symbol] V_{MAX}(V_{ANALOG}_{_{—}}_{IN})≦3.6

### For a Conversion Engine (E)

1) The sum of the peak currents (I_{PEAK}) for the conversion engine's attached power sinks (power consuming components) must be less than or equal to its absolute maximum output current (i.e., maximum current a source can supply (I_{SRC}_{_{—}}_{MAX}):

$${\sum }_{∀ s ∈ Sinks ( E )} {I}_{PEAK} ( s ) \leq {I}_{SRC\_MAX} ( E )$$

2) With the assumption that the current on E is I_{PEAK}(E), the peak inductor current is computed for E. If I_{MAX}_{_{—}}_{INTERNAL} is the highest internal current (i.e., the peak inductor current), then the following must hold:

I_{L}_{_{—}}_{PEAK}(E)≦I_{MAX}_{_{—}}_{INTERNAL}(E,V_{NOM}(V_{IN}),V_{MAX}(E))
3) Validation tests on current limits during voltage transitions can be defined as: Given the following definitions,

$$\frac{d V}{d {T}_{ON}} = \frac{{V}_{NOM\_ADJ} ( E )}{TON\_RISE}$$

$$\frac{d V}{d {T}_{OFF}} = \frac{{V}_{NOM\_ADJ} ( E )}{TOFF\_FALL}$$

$${V}_{TRANS\_RATE} = VOUT\_TRANSITION \_RATE$$

C is the capacitance on E,
I_{SRC}_{_{—MAX}}(P): Maximum current that the source can supply
I_{OC}_{_{—}}_{FAULT}(P): The over-current fault limit for power source P. then the following must hold:
C·dV/dT_{ON}≦I_{SRC}_{_{—}}_{MAX}(E)
C·dV/dT_{ON}≦I_{MAX}_{_{—}}_{INTERNAL}(E, V_{MAX}(V_{IN}),V_{NOM}_{_{—}}_{ADJ}(E))
C·dV/dT_{ON}≦I_{OC}_{_{—}}_{FAULT}(E)
C·dV/dT_{OFF}≧I_{SRC}_{_{—}}_{MIN}(E)
C·dV/dT_{OFF}≧I_{MIN}_{_{—}}_{INTERNAL}(E,?,?)
C·dV/dT_{OFF}≧I_{UC}_{_{—}}_{FAULT}(E)
C·V_{TRANS}_{_{—}}_{RATE}≦I_{SRC}_{_{—}}_{MAX}(E)
C·V_{TRANS}_{_{—}}_{RATE}≦MAX_{_{—}}_{INTERNAL}(E,V_{MAX}(V_{IN}),V_{NOM}_{_{—}}_{ADJ}(E))
C·V_{TRANS}_{_{—}}_{RATE}≦I_{OC}_{_{—}}_{FAULT}(E)
C·V_{TRANS}_{_{—}}_{RATE}≧I_{SRC}_{_{—}}_{MIN}(E)
C·V_{TRANS}_{_{—}}_{RATE}≧I_{MIN}_{_{—}}_{INTERNAL}(E,?,?)

C·−V_{TRANS}_{_{—}}_{RATE}≧I_{UC}_{_{—}}_{FAULT}(E)
where,
4) The CRC of any supplied custom compensator must be verified. For example, the Studio interface presents 5 fields into which byte values can be entered. The first 4 are the actual compensator coefficients and the 5^{th} byte is an 8-bit CRC of those bytes. The generator polynomial is x⁸+x²+x+1.
5) If E is in threshold sequencing mode with a reference rail R, then there may be one or both of a turn-on (V_{ON}(R)) and turn-off (V_{OFF}(R)) voltage level(s) defined. If defined these must satisfy: V_{ON}(R)<V_{MIN}(R) and V_{OFF}(R)<V_{MIN}(R), where V_{MIN}(R) is the minimum voltage within regulation on the reference rail.

### For a Load (L)

1) As a power sink, a load (L) needs to be connected to one or more power sources.
2) The nominal load current (I_{NOM}(L)) should be less than or equal to the peak load current (I_{PEAK}(L)): I_{NOM}(L)<=I_{PEAK}(L)
3) The maximum voltage (V_{MAX}) from any connected power source should be within the maximum tolerated voltage limit without damage to the load ∀sεSources(L),V_{MAX}(s)<V_{ABS}_{_{—}}_{MAX}(L)

### (V_{ABS}_{_{—}}_{MAX})

4) Load (L) should also satisfy regulation requirements.
   Given that: P is a power source for L,

$$MinVoltageDelivered ( P ) = {V}_{NOM} ( P ) - {V}_{ABS\_REG} ( P ) \cdot {V}_{NOM} ( P ) - {V}_{DIG\_RIPPLE} ( P ) - {V}_{NEG\_TRANS} ( P )$$

$$MaxVoltageDelivered ( P ) = {V}_{NOM} ( P ) + {V}_{ABS\_REG} ( P ) \cdot {V}_{NOM} ( P ) + {V}_{DIG\_RIPPLE} ( P ) + {V}_{POS\_TRANS} ( P )$$

where,
V_{NOM}(P): Nominal power source set point.
V_{ABS}_{_{—}}_{REG}(P): Absolute regulation performance of the supply rail (power converter specific data)
V_{DIG}_{_{—}}_{RIPPLE}(P): Estimated ripple due to both switching and the effect of the digital compensator.
V_{NEG}_{_{—}}_{TRANS}(P): Expected negative deviation from nominal voltage due to a current transient.
V_{POS}_{_{—}}_{TRANS}(P): Expected positive deviation from nominal voltage due to a current transient.
then the following must hold:
∀sεSources(L),V_{MIN}(L)≦MinVoltageDelivered(s)
∀sεSources(L),V_{MAX}(L)≦MaxVoltageDelivered(s)

As already stated, the above are example constraints and validation tests that should not be used to limit embodiments or claim scope. For instance, example number three of validations tests for the conversion engine may not be used in a power system. A power system design tool can use power converter metadata that governs current limits during voltage transitions.

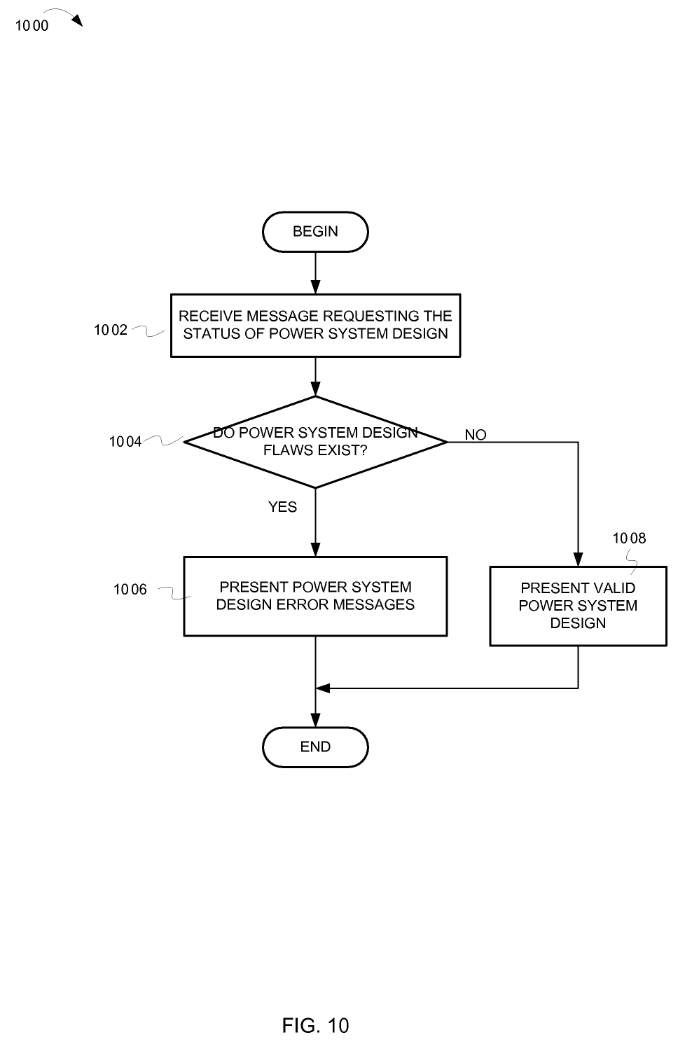

FIG. 10 depicts a flow diagram of example operations for generating power system design feedback. The flow 1000 begins at block 1002.

At block 1002, a message requesting the status of a proposed power system design is received. In some instances, a power system status message can be generated every time the power system design is modified, errors are generated, or errors are resolved. In some instances, a user can request the power system design status by clicking on an option in the user interface. In other instances, the status of the power system design may be automatically requested in response to a configuration file generation request. The flow continues at block 1004.

At block 1004, it is determined whether power system design flaws exist. In some instances, a feedback event or metric can be accessed to determine whether there are power system design errors. In other instances, a database including a set of design violations can be accessed to determine whether there are unresolved power system design flaws. If it is determined that there are unresolved design flaws, the flow continues at block 1006. Otherwise, the flow continues at block 1008.

At block 1006, power system design validation messages are presented. In some instances, a prompt to resolve all design errors can be presented. In other instances, suggestions for resolving the errors can be displayed on the design tool's interface. From block 1006, the flow ends.

At block 1008, the valid power system design is presented. In some instances, a message indicating a “valid power system design” can be presented. In other instances, a configuration file for the power converter can be automatically generated after the power system design has been validated. From block 1008, the flow ends.

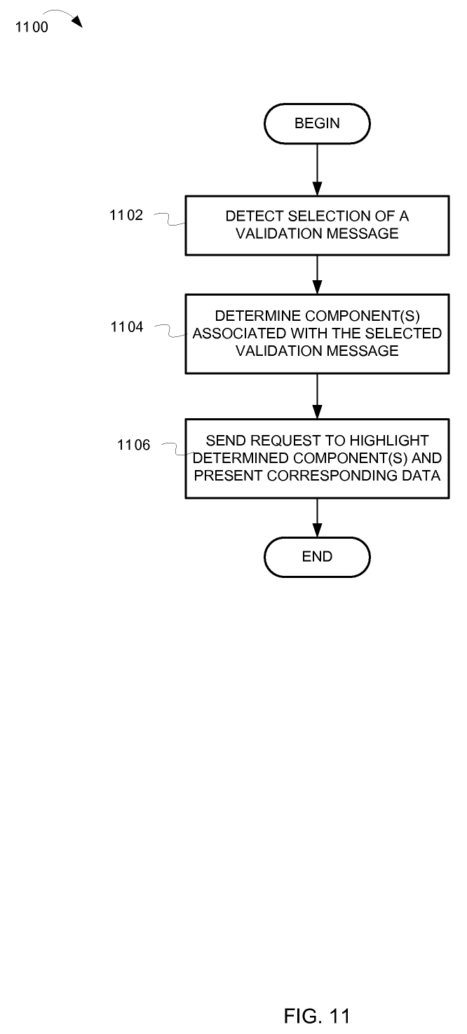

FIG. 11 depicts a flow diagram of example operations for design error notification. The flow 1100 begins at block 11102.

At block 1102, selection of a validation message is detected. The incoming request could be in response to a user clicking on a validation message in the feedback display area in the design tool's user interface. The flow continues at block 1104.

At block 1104, one or more components associated with a selected validation message are determined. In some instances, the validation message and the specifications associated with the validation message can be stored in a database. In other instances, the power system design tool can include logic to determine the components or parameters that may be associated with a selected validation message. The power system design tool can also access a design specifications database to determine a specific component associated with the selected validation message. The flow continues at block 11106.

At block 1106, a request to highlight the determined component(s) and present data that corresponds to the determined component(s) is sent to the power system design tool interface. For example, if the user clicks on a validation message associated with the power converter's peak output voltage, the power system design tool can highlight the associated power converter's output voltage terminal and display data that corresponds to the component (e.g., peak value, voltage regulation, etc). The user can then use the user interface to modify the specifications and resolve the error. From block 1106, the flow ends.

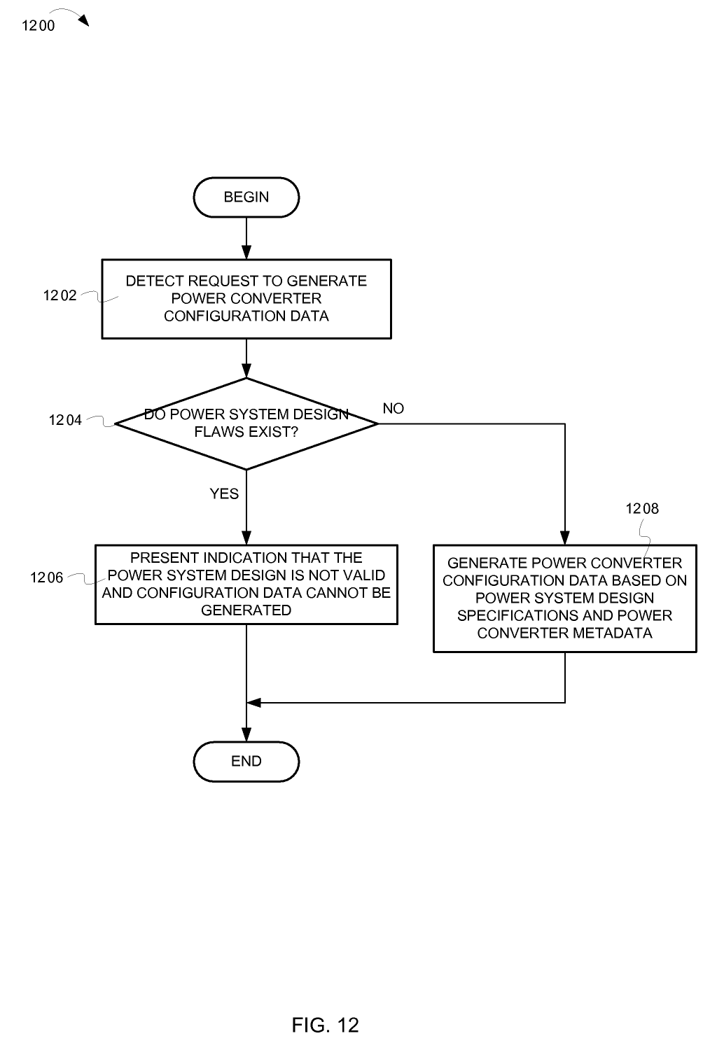

FIG. 12 depicts a flow diagram of example operations for generating a power converter configuration file. The flow 1200 begins at block 1202.

At block 1202, a request to generate a power converter configuration data is detected. In some instances, the incoming request can originate in response to a user clicking on a user interface component (e.g., a drop down menu) in the power system design tool interface to generate power converter configuration data (as shown in FIG. 3). In other instances, an automatic request to create power converter configuration data may be generated in response to a feedback event (indicating a valid power system design). The flow continues at block 1204.

At block 1204, it is determined whether power system design flaws exist. In some instances, the power system design tool can access the feedback event to determine whether there are power system design errors. In other instances, a database including a list of constraint violations can be accessed to determine whether there are unresolved design flaws. If there are unresolved flaws in the power system design, the flow continues at block 1206. Otherwise, the flow continues at block 1208.

At block 1206, an indication that the power system design is not valid and power converter configuration data cannot be generated is presented. To prevent component damage or unexpected operations, the power converter configuration data may not be generated until the power system design is valid and error-free. The unresolved power system design flaws and suggestions to resolve these flaws can be presented on the power system design tool's interface. In some instances, the user can also be prompted to clear all design errors before generating a configuration file. In other instances, the power system design tool can refuse to acknowledge further design modifications to the design schematic until all the errors have been resolved. From block 1206, the flow ends.

At block 1208, the power converter configuration data is generated based on the power system design specifications and the power converter metadata. The power converter configuration data can include information to enable the power converter to have the desired performance when in operation with other components in a system. After the configuration data is generated, it can be loaded into the power converter chip. The power converter can then be initialized, and connected to the desired system. From block 1208, the flow ends.

It should be understood that the depicted flow diagrams are examples meant to aid in understanding embodiments and should not be used to limit embodiments or limit scope of the claims. Embodiments may perform additional operations, fewer operations, operations in a different order, operations in parallel, and some operations differently. For instance, in FIG. 5, block 508 may be performed before or in parallel with block 506. As another example, blocks 506, 508, and 510 of FIG. 5 may not be performed unless a command is received, a power system design reaches a particular threshold (e.g., at least three components are in the schematic display area), etc. As another example, in FIG. 9, blocks 904 and 906 may be performed in parallel, in different order, etc. In addition, operations can be performed to check the power system constraints, and postpone generating and/or evaluating power converter constraints until the power system constraints are satisfied.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, embodiments may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language (e.g., Java, Smalltalk, C++, etc.) and conventional procedural programming languages (e.g., “C” programming language). The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

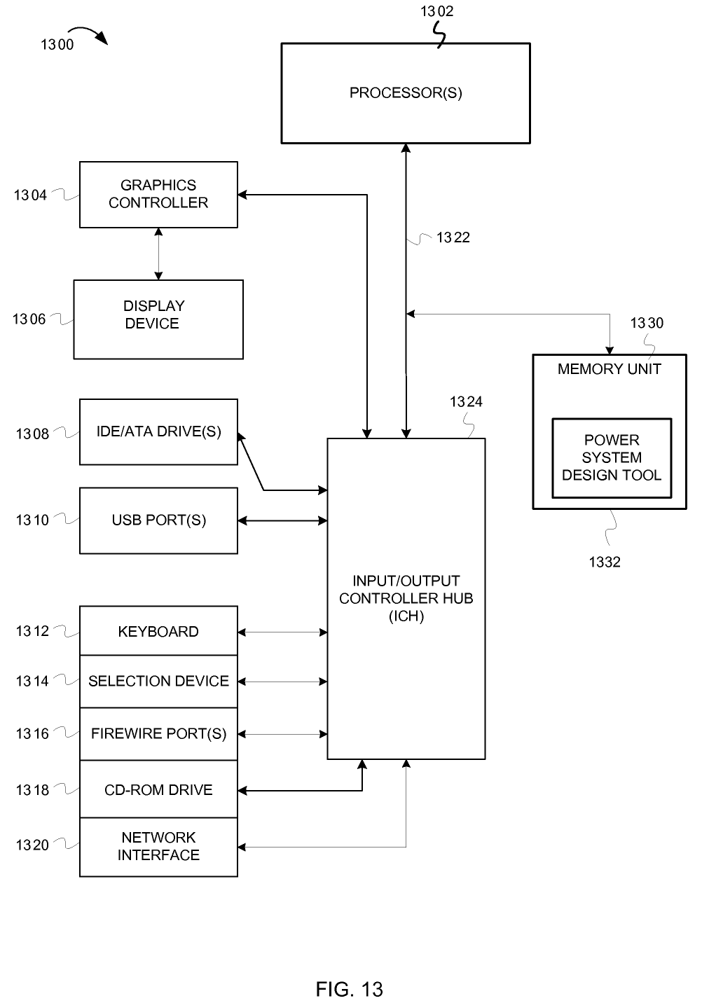

FIG. 13 depicts an example computer system that embodies a power system design tool. The computer system 1300 includes a processor 1302. The processor 1302 is connected to an input/output controller hub 1324 (ICH), also known as a south bridge, via a bus 1322 (e.g., PCI, ISA, PCI-Express, HyperTransport, etc). A memory unit 1330 interfaces with the processor 1302 and the ICH 1324. The main memory unit 1330 can include any suitable random access memory (RAM), such as static RAM, dynamic RAM, synchronous dynamic RAM, extended data output RAM, etc. The ICH 1324 connects and controls peripheral devices. In FIG. 13, the ICH 1324 is connected to IDE/ATA drives 1308 (used to connect external storage devices) and to universal serial bus (USB) ports 1310. The ICH 1324 may also be connected to a keyboard 1312, a selection device 1314, firewire ports 1316 (for use with video equipment), CD-ROM drive 1318, and a network interface 1320. The ICH 1324 can also be connected to a graphics controller 1304. The graphics controller is connected to a display device 1306 (e.g., monitor).

In one embodiment, the memory unit 1330 includes a power system design tool 1332. The power system design tool includes logic to receive power system design specifications (e.g., design schematic, component parameters, connections between components, etc.) via an interface and dynamically generate a set of constraints based on the design specifications and power converter metadata. The power system design tool 1332 can also verify whether the proposed power system design satisfies all the design constraints, determine conflicting specifications that could potentially represent an error, and in some instances also suggest solutions to resolve the design errors. The power system design tool 1332 can also generate device (power converter) configuration data after the proposed power system design is deemed to be free of errors.

Although FIG. 13 shows the power system design tool 1332 in memory 1330, the design tool need not be embodied in the memory. For example, the power system design tool may reside on a CD in the CD-ROM drive, on the hard drive, on an ASIC (not shown), etc. In some embodiments, the computer system 1300 can include additional devices and/or more than one of each component shown in FIG. 13 (e.g., video cards, audio cards, peripheral devices, etc.). For example, in some instances, the computer system 1300 may include multiple processors, multiple cores, multiple external CPU's. In other instances, components may be integrated or subdivided.

While the embodiments are described with reference to various implementations and exploitations, it will be understood that these embodiments are illustrative and that the scope of the inventive subject matter is not limited to them. In general, a design tool for configuration and validation of one or more power converters in a power system are described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
dynamically deriving a set of one or more power system constraints based, at least in part, on design specifications for a power system design and power system constraint expressions embodied in one or more machine-readable media, wherein the set of one or more power system constraints comprise one or more of an electrical constraint, a thermodynamic constraint, and a logical constraint;
dynamically deriving a set of one or more power converter constraints based, at least in part, on data about a power converter, power converter constraint expressions, and the design specifications for the power system design, wherein the power system design indicates the power converter;
evaluating the power system design using the dynamically derived set of power system constraints and the dynamically derived set of power converter constraints; and
generating configuration data for configuring the power converter based, at least in part, on the design specifications and the data about the power converter if said evaluating indicates the power system design as valid.

2. The method of claim 1 further comprising updating a graphical user interface to indicate the power system design as valid based on said evaluating.

3. The method of claim 1, wherein the power system constraint expressions and power converter constraint expressions comprise at least one of device performance expressions, device limitation expressions, and device operating characteristics.

4. The method of claim 1 further comprising generating the design specifications from a graphical representation of the power system design and parameters associated with the graphical representation.

5. The method of claim 1 further comprising generating feedback about the power system design based, at least in part, on said evaluating.

6. A method comprising:
dynamically deriving a set of constraints based, at least in part, on constraint expressions and design specifications for a power system design embodied in one or more machine-readable media;
determining if the power system design satisfies the dynamically derived set of constraints;
indicating the power system design as valid if the power system design satisfies the dynamically derived set of constraints; and
indicating those of the dynamically derived set of constraints that are violated by the power system design if the power system does not satisfy the dynamically derived set of constraints.

7. The method of claim 6, wherein the constraint expressions comprise power converter constraint expressions and power system constraint expressions.

8. The method of claim 6, wherein said indicating those of the dynamically derived set of constraints that are not satisfied by the power system design comprises:
generating a message that identifies one or more components of the power system design that correspond to the violated ones of the dynamically derived set of constraints; and
modifying a graphical representation of the power system design to indicate the one or more components identified by the message.

9. A power system design tool embodied as instructions stored in one or more machine-readable media, which when executed by a set of one or more processors causes the set of one or more processor to perform operations that comprise:
determining that a power system design satisfies a dynamically derived set of power system constraints and a dynamically derived set of power converter constraints, wherein the power system design indicates a power converter;
generating power converter configuration data based, at least in part, on design specifications for the power system design and data about the power converter; and
loading the generated power converter configuration data into the power converter to configure the power converter in accordance with the power system design determined to satisfy the dynamically derived set of power system constraints and the dynamically derived set of power converter constraints.

10. The power system design tool of claim 9, wherein the operations further comprise:
dynamically deriving the set of power system constraints based, at least in part, on design specifications of the power system design and power system constraint expressions that indicate at least one of desired performance and limitations of the power system design; and
dynamically deriving the set of power converter constraints based, at least in part, on the design specifications, data about the power converter, and power converter constraint expressions, wherein the power converter constraint expressions indicate at least one of desired performance of the power converter and limitations of the power converter.

11. The power system design tool of claim 10, wherein the data about the power converter indicates operating characteristics of the power converter.

12. One or more machine-readable media, having instructions stored therein, which when executed by a set of one or more processors causes the set of one or more processors to perform operations that comprise:
dynamically deriving a set of one or more power system constraints based, at least in part, on design specifications for a power system design and power system constraint expressions, wherein the set of one or more power system constraints comprise one or more of an electrical constraint, a thermodynamic constraint, and a logical constraint;
dynamically deriving a set of one or more power converter constraints based, at least in part, on data about a power converter, power converter constraint expressions, and the design specifications for the power system design, wherein the power system design indicates the power converter;
evaluating the power system design using the dynamically derived set of power system constraints and the dynamically derived set of power converter constraints; and
generating configuration data for configuring the power converter based, at least in part, on the design specifications and the data about the power converter if said evaluating indicates the power system design as valid.

13. The machine-readable media of claim 12, wherein the power system constraint expressions comprise equations and inequalities that express at least one of desired performance and limitations for the power system design, wherein the power converter constraint expressions comprise equations and inequalities that express at least one of performance and limitations for the power converter.

14. The machine-readable media of claim 12, wherein the operations further comprising generating the design specifications from a graphical representation of the power system design and parameters associated with the graphical representation.

15. The machine-readable media of claim 12, wherein the operations further comprise generating feedback about the power system design based, at least in part, on said evaluating operation.

16. One or more machine-readable media, having instructions stored therein, which when executed by a set of one or more processors causes the set of one or more processors to perform operations that comprise:
dynamically deriving a set of constraints based, at least in part, on constraint expressions and design specifications for a power system design;
determining if the power system design satisfies the dynamically derived set of constraints;
indicating the power system design as valid if the power system design satisfies the dynamically derived set of constraints; and
indicating those of the dynamically derived set of constraints that are violated by the power system design if the power system does not satisfy the dynamically derived set of constraints.

17. The machine-readable media of claim 16, wherein said operation of indicating those of the dynamically derived set of constraints that are not satisfied by the power system design comprises generating messages that identify components of the power system design that correspond to the violated ones of the dynamically derived set of constraints.

18. An apparatus comprising:
a set of one or more processors;
one or more machine-readable media coupled with the set of one or more processors, the one or more machine-readable media operable to host a power system design;
a power system constraint generator operable to dynamically derive a set of one or more power system constraints based, at least in part, on design specifications for a power system design and power system constraint expressions;
a power converter constraint generator operable to dynamically derive a set of one or more power converter constraints based, at least in part, on data about a power converter, power converter constraint expressions, and the design specifications for the power system design, wherein the power system design indicates the power converter; and
a validation engine coupled with the power system constraint generator and the power converter constraint generator, the validation engine operable to evaluate the power system design based, at least in part, on the design specifications and the sets of constraints dynamically derived by the power converter constraint generator and the power system constraint generator, and further operable to indicate whether the power system design satisfies the sets of constraints or violates one or more of the sets of constraints.

19. The apparatus of claim 18 further comprising a power converter configuration generator coupled with the validation engine, the power converter configuration generator operable to generate configuration data for a power converter to configure the power converter in accordance with the power system design.

20. The apparatus of claim 19, wherein the power converter is further operable determine if the power system design satisfies the sets of constraints according to the validation engine and operable to condition generation of the power converter configuration data on satisfaction of the sets of constraints.

21. The apparatus of claim 18, wherein the power system constraint generator, the power converter constraints generator, and the validation engine are embodied in the one or more machine-readable media.
